(19) United States
(12) Patent Application Publication
(10) Pub. No.: US 2026/0074571 A1
(43) Pub. Date: Mar. 12, 2026

(54) POWER AND COMMUNICATIONS REGULATION FOR WIRELESS POWER TRANSFER

(71) Applicant: Apple Inc., Cupertino, CA (US)

(72) Inventors: Elyh V. Lapetina, Burlingame, CA (US); Vladimir N. Vitchev, San Jose, CA (US); David A. Vakshlyak, Milpitas, CA (US); Chongwen Zhao, Shanghai (CN)

(21) Appl. No.: 19/262,719

(22) Filed: Jul. 8, 2025

Related U.S. Application Data
(60) Provisional application No. 63/691,413, filed on Sep. 6, 2024.

(51) Int. Cl. H02J 50/80; H02J 7/00; H02J 50/10

(52) U.S. Cl. CPC H02J 50/80; H02J 7/42; H02J 50/10; H02J 2207/20

(57) ABSTRACT

A wireless power receiver (PRx) can include regulator control circuitry that monitors a rectifier output voltage and/or current and reduces a power level of the regulator if the monitored voltage or current is above a threshold to maintain stability of a wireless power transfer link. A PRx can include control circuitry that can, responsive to a need for an increased wireless power transfer, compute a power feedback parameter in accordance with a first equation or, responsive to a need for a decreased wireless power transfer, compute the power feedback parameter in accordance with a second equation, and send a communication packet including the power feedback parameter to a wireless power transmitter. The wireless power receiver control circuitry can further send the communication packet according to a first or second communications loading control policy that can temporarily reduce output power during transmission.

### CROSS-REFERENCE TO RELATED APPLICATIONS

This application claims priority to U.S. Provisional Application No. 63/691,413, filed September 6, 2024, which is incorporated by reference herein in its entirety.

### BACKGROUND

Wireless power transfer is used in various electronic devices. For example, smart phones, tablet computers, smart watches, wireless earphones, styluses, etc. may employ wireless power transfer to facilitate charging of batteries within the devices and/or to power the devices during operation.

### SUMMARY

A wireless power receiver can include a wireless power receiving coil having an AC voltage induced thereacross by a wireless power transmitting coil of a wireless power transmitter when the wireless power transmitting coil is magnetically coupled to the wireless power receiving coil; a rectifier comprising a plurality of switching devices having an input that receives the AC voltage across the wireless power receiving coil and produces a rectifier output voltage; wireless power receiver control circuitry that operates the switching devices of the regulator and communicates with the wireless power transmitter; a regulator that receives the DC output voltage of the rectifier and produces a regulated output voltage provided to at least one of a battery of the wireless power receiver or one or more system loads of the wireless power receiver; and regulator control circuitry. The regulator control circuitry can monitor at least one of the rectifier output voltage or a rectifier output current; compare the monitored rectifier output voltage or rectifier output current a threshold; and reduce a power level of the regulator if the monitored rectifier output voltage or rectifier output current is above a threshold, to maintain stability of a wireless power transfer link between the wireless power receiver and the wireless power transmitter.

The regulator can be a constant power converter. The regulator can be a three-level buck converter. The threshold can be selected based on an operating voltage of the wireless power transmitter. The regulator control circuitry can infer the operating voltage of the wireless power transmitter from the rectifier output voltage. The regulator control circuitry can receive the operating voltage of the wireless power transmitter from one of the wireless power receiver circuitry or control circuitry of the wireless power transmitter. The wireless power receiver control circuitry and regulator control circuitry can be integrated into a common controller.

A wireless power receiver can include a wireless power receiving coil having an AC voltage induced thereacross when the wireless power transmitting coil is magnetically coupled to by a wireless power transmitting coil of a wireless power transmitter; a rectifier comprising a plurality of switching devices having an input that receives the AC voltage across the wireless power receiving coil and produces a rectifier output voltage; and wireless power receiver control circuitry that operates the switching devices of the regulator and communicates with the wireless power transmitter. The wireless power receiver control circuitry can further monitor the rectifier output voltage and determines a rectifier voltage error by comparing the rectifier output voltage to a reference; responsive to the rectifier voltage error indicating a need for an increased wireless power transfer level, compute a power feedback parameter based on the rectifier voltage error in accordance with a first equation; responsive to the rectifier voltage error indicating a need for a decreased wireless power transfer level, compute the power feedback parameter based on the rectifier voltage error parameter in accordance with a second equation; and send a communication packet including the power feedback parameter to the wireless power transmitter.

The communication packet can be a control error packet, wherein the power feedback parameter is a control error packet parameter, and wherein a value of the power feedback parameter according to the first equation for a given rectifier voltage error is greater than a value of the power control parameter according to the second equation for the given rectifier voltage error. The first equation can be a linear equation. The second equation can be a polynomial equation.

The wireless power receiver control circuitry can further determine whether the wireless power transfer system is power limited; and responsive to the wireless power transfer system not being power limited, send the communication packet according to a first communications loading control policy; and responsive to the wireless power transfer system being power limited, send the communication packet according to a second communications loading policy. The second communication loading policy can provide for a temporary reduction in rectifier power during transmission of the control error packet. The temporary reduction in rectifier power can correspond to a power level selected from the group consisting of: 90%, 85%, 80%, 75%, 70%, or 65%. of rectifier power prior to the temporary reduction. The first communication loading policy can provide for a first temporary reduction in rectifier power during transmission of the control error packet, and the second communication loading policy can provide for a second temporary reduction in rectifier power greater than the first temporary reduction in rectifier power during transmission of the communication packet. The first temporary reduction in rectifier power can correspond to a power level selected from the group consisting of: 95%, 90%, or 85% of rectifier power prior to the temporary reduction; and the second temporary reduction in rectifier power can correspond to a power level selected from the group consisting of: 90%, 85%, 80%, 75%, 70%, or 65% of rectifier power prior to the temporary reduction.

A wireless power receiver can include a wireless power receiving coil having an AC voltage induced thereacross by a wireless power transmitting coil of a wireless power transmitter when the wireless power transmitting coil is magnetically coupled to the wireless power receiving coil; a rectifier comprising a plurality of switching devices having an input that receives the AC voltage across the wireless power receiving coil and produces a rectifier output voltage; and wireless power receiver control circuitry that operates the switching devices of the regulator and communicates with the wireless power transmitter. The wireless power receiver control circuitry can determine whether the wireless power transfer system is power limited; and, responsive to the wireless power transfer system not being power limited, send the control error packet according to a first communications loading control policy; and, responsive to the wireless power transfer system being power limited, send the control error packet according to a second communications loading policy.

The second communication loading policy can provide for a temporary reduction in rectifier power during transmission of the control error packet. The temporary reduction in rectifier power can correspond to a power level selected from the group consisting of: 90%, 85%, 80%, 75%, 70%, or 65% of rectifier power prior to the temporary reduction. The first communication loading policy can provide for a first temporary reduction in rectifier power during transmission of the control error packet, and the second communication loading policy provides for a second temporary reduction in rectifier power greater than the first temporary reduction in rectifier power during transmission of the control error packet. The first temporary reduction in rectifier power can correspond to a power level selected from the group consisting of: 95%, 90%, or 85% of rectifier power prior to the temporary reduction; and the second temporary reduction in rectifier power corresponds to a power level selected from the group consisting of: 90%, 85%, 80%, 75%, 70%, or 65% of rectifier power prior to the temporary reduction.

### BRIEF DESCRIPTION OF THE DRAWINGS

FIG. 1 illustrates a simplified block diagram of a wireless power transfer system.

FIG. 2 illustrates a block diagram of a wireless power receiver device.

FIG. 3 illustrates a further simplified block diagram of a wireless power transfer system and an illustration of associated stability implications.

FIG. 4 illustrates a flow chart of regulation and communication techniques for a wireless power transfer system.

FIG. 5 illustrates respective regulation gain equations for use in a wireless power transfer system.

FIG. 6 illustrates a simplified flow chart of a power regulation and communication technique for a wireless power transfer system.

### DETAILED DESCRIPTION

In the following description, for purposes of explanation, numerous specific details are set forth to provide a thorough understanding of the disclosed concepts. As part of this description, some of this disclosure’s drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose. Any trademarks referenced herein are intended to only to identify examples and are property of their respective owners.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

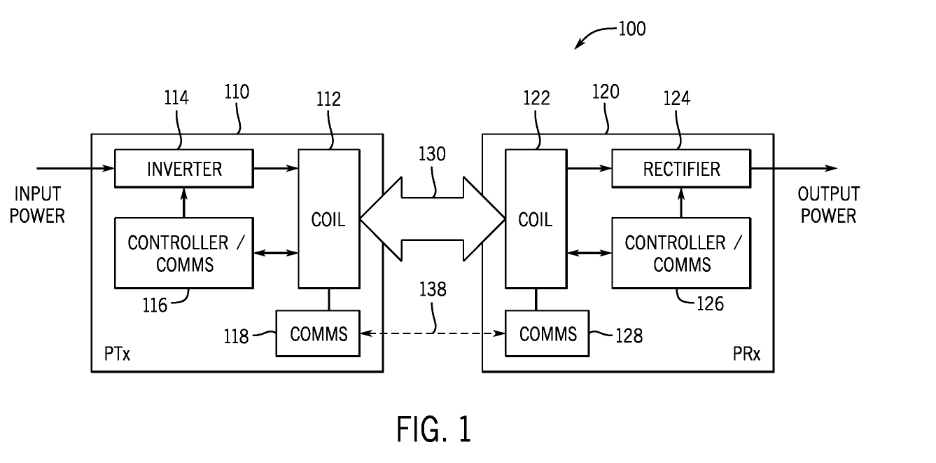

FIG. 1 illustrates a simplified block diagram of a wireless power transfer system 100. Wireless power transfer system includes a power transmitter (PTx) 110 that transfers power to a power receiver (PRx) 120 wirelessly, such as via inductive coupling 130. Power transmitter 110 may receive input power that is converted to an AC voltage having particular voltage and frequency characteristics by an inverter 114. Inverter 114 may be controlled by a controller/communications module 116 that operates as further described below. In various embodiments, the inverter controller and communications module may be implemented in a common system, such as a system based on a microprocessor, microcontroller, or the like. In other embodiments, the inverter controller may be implemented by a separate controller module and communications module that have a means of communication between them. Inverter 114 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

Inverter 114 may deliver the generated AC voltage to a transmitter coil 112. In addition to a wireless coil allowing magnetic coupling to the receiver, the transmitter coil block 112 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless transmitter coil may also include a core of magnetically permeable material (e.g., ferrite) configured to affect the flux pattern of the coil in a way suitable to the particular application. The teachings herein may be applied in conjunction with any of a wide variety of transmitter coil arrangements appropriate to a given application.

PTx controller/communications module 116 may monitor the transmitter coil and use information derived therefrom to control the inverter 114 as appropriate for a given situation. For example, controller/communications module may be configured to cause inverter 114 to operate at a given frequency or output voltage depending on the particular application. In some embodiments, the controller/communications module may be configured to receive information from the PRx device and control inverter 114 accordingly. This information may be received via the power transmission coils (i.e., in-band communication) or may be received via a separate communications channel (not shown, i.e., out-of-band communication). For in-band communication, controller/communications module 116 may detect and decode signals imposed on the magnetic link (such as voltage, frequency, or load variations) by the PRx to receive information and may instruct the inverter to modulate the delivered power by manipulating various parameters of the generated voltage (such as voltage, frequency, etc.) to send information to the PRx. In some embodiments, controller/communications module may be configured to employ frequency shift keying (FSK) communications, in which the frequency of the inverter signal is modulated, to communicate data to the PRx. Controller/communications module 116 may be configured to detect amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 116 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry.

PTx device 110 may optionally include other systems and components, such as a separate communications module 118. In some embodiments, comms module 118 may communicate with a corresponding module tag in the PRx via the power transfer coils. In other embodiments, comms module 118 may communicate with a corresponding module using a separate physical channel 138.

As noted above, wireless power transfer system also includes a wireless power receiver (PRx) 120. Wireless power receiver can include a receiver coil 122 that may be magnetically coupled 130 to the transmitter coil 112. As with transmitter coil 112 discussed above, receiver coil block 122 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless receiver coil may also include a core of magnetically permeable material (e.g., ferrite) configured to affect the flux pattern of the coil in a way suitable to the particular application. The teachings herein may be applied in conjunction with any of a wide variety of receiver coil arrangements appropriate to a given application.

Receiver coil 122 outputs an AC voltage induced therein by magnetic induction via transmitter coil 112. This output AC voltage may be provided to a rectifier 124 that provides a DC output power to one or more loads associated with the PRx device. Rectifier 124 may be controlled by a controller/communications module 126 that operates as further described below. In various embodiments, the rectifier controller and communications module may be implemented in a common system, such as a system based on a microprocessor, microcontroller, or the like. In other embodiments, the rectifier controller may be implemented by a separate controller module and communications module that have a means of communication between them. Rectifier 124 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

PRx controller/communications module 126 may monitor the receiver coil and use information derived therefrom to control the rectifier 124 as appropriate for a given situation. For example, controller/communications module may be configured to cause rectifier 124 to operate provide a given output voltage depending on the particular application. In some embodiments, the controller/communications module may be configured to send information to the PTx device to effectively control the power delivered to the receiver. This information may be received sent via the power transmission coils (i.e., in-band communication) or may be sent via a separate communications channel (not shown, i.e., out-of-band communication). For in-band communication, controller/communications module 126 may, for example, modulate load current or other electrical parameters of the received power to send information to the PTx. In some embodiments, controller/communications module 126 may be configured to detect and decode signals imposed on the magnetic link (such as voltage, frequency, or load variations) by the PTx to receive information from the PTx. In some embodiments, controller/communications module 126 may be configured to receive frequency shift keying (FSK) communications, in which the frequency of the inverter signal has been modulated to communicate data to the PRx. Controller/communications module 126 may be configured to generate amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 126 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry. PRx device 120 may optionally include other systems and components, such as a communications (“comms”) module 128. In some embodiments, comms module 128 may communicate with a corresponding module in the PTx via the power transfer coils. In other embodiments, comms module 128 may communicate with a corresponding module or tag using a separate physical channel 138.

Numerous variations and enhancements of the above-described wireless power transmission system 100 are possible, and the following teachings are applicable to any of such variations and enhancements.

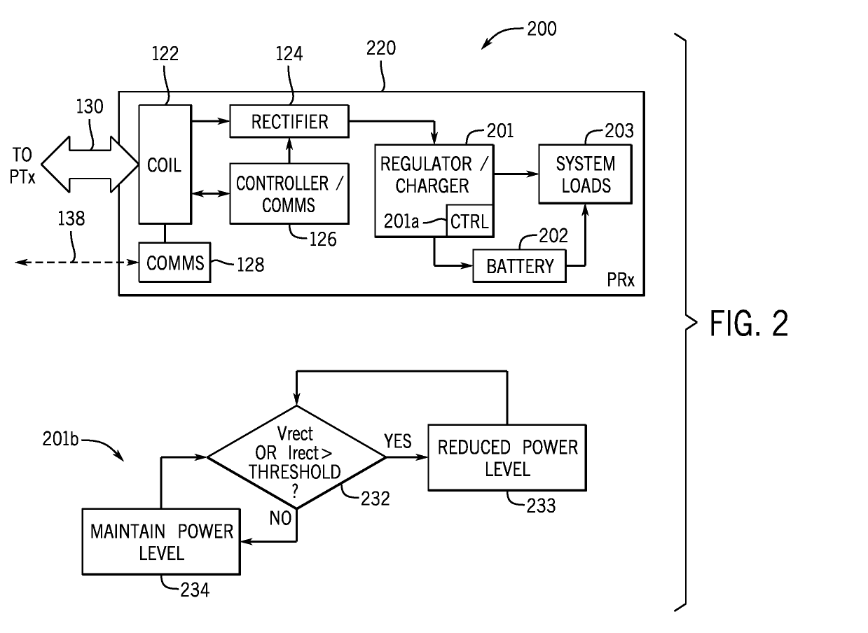

FIG. 2 illustrates a block diagram of a wireless power receiver (PRx) device 200. Many components of PRx device 200 were described above with reference to FIG. 1. FIG. 2 further illustrates a regulator/charger 201 that may be connected as a load to rectifier 124. In other words, regulator/charger 201 can present a load that is represented by the “Output Power” depicted in FIG. 1. Regulator/charger 201 can serve various purposes. In some applications, regulator charger 201 can convert the output voltage of rectifier 124 (sometimes called “Vrect”) to a target voltage for charging a battery 202. In some applications, regulator charger 201 can convert Vrect to a suitable level for powering system loads 203, which can be various processing, storage, display, communication, and/or input/output systems of PRx device 200. In some applications, these system loads 203 can be powered by battery 202, potentially with another regulator between the battery and the system loads and/or with regulator charger 201 being operable both to charge battery 202 and power the system loads 203, whether from the wireless power transfer system, a wired power transfer system, and/or battery 202 (when an external power source, wired or wireless, is not available). Thus, the block diagram of FIG. 2 may be simplified as there may be multiple regulator/chargers connected to the output of rectifier 124 of the wireless power transfer system.

Regulator/charger 201 can be implemented using various topologies. In some embodiments, regulator/charger 201 can be implemented as a switched capacitor converter (e.g., a charge pump). In other embodiments, regulator/charger 201 can be implemented as an inductive switching converter, such as a buck converter, boost converter, buck-boost converter, multi-level buck converter, etc. In some embodiments this could include a three-level buck converter. In general, these topologies will include some arrangement of one or more switching devices, one or more energy storage devices (e.g., inductors), and control circuitry 201a that operates the switching devices in conjunction with the energy storage devices to produce a desired output voltage and/or current. The control circuitry can include any appropriate combination of analog, digital, and/or programmable circuitry to implement a desired control algorithm or technique to achieve the desired voltage and/or current regulation. Various such converter topologies are known to those skilled in the art, and thus will not be discussed in detail herein.

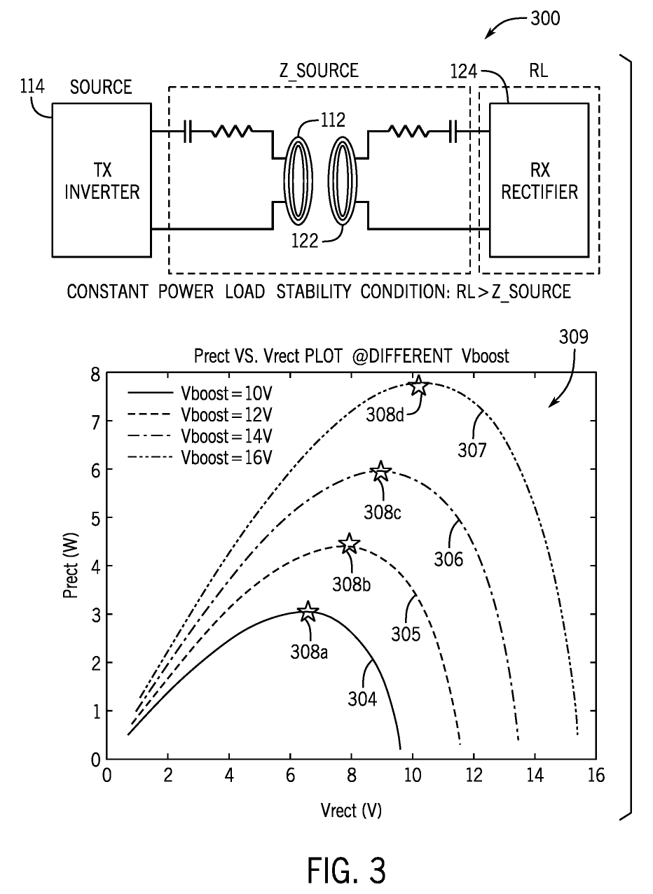

In some embodiments and applications, certain converter topologies, such as a three-level buck converter, can exhibit a constant power characteristic that can lead to instability of the wireless power transfer system if the power exceeds a certain stability threshold, as described in greater detail below with reference to FIG. 3. To that end, controller circuitry 201a can implement a protection system as depicted in flowchart 201b. As one example, the controller circuitry 201a can monitor the power being drawn from rectifier 124, which can be represented by the rectifier output voltage (Vrect) and/or rectifier output current (Irect). The output power of rectifier 124, and thus the output power of the wireless power transfer system, is the product of these two parameters and is proportional to the square of each of these parameters. Thus, by determining whether one or the other or both of these parameters exceeds some predetermined threshold (block 232), control circuitry 201a can determine whether a reduction in power level is necessary (block 233) or whether the present power level can be maintained (block 234). The threshold can be determined or selected based on an operating voltage of the wireless power transmitter, which can be inferred from the wireless power receiver rectifier output voltage or can be received via communication with the wireless power receiver control circuitry and/or the wireless power transmitter control circuitry. Flowchart 201b is a simplification of the control techniques or algorithms that can be implemented by control circuitry 201a, and additional measurements of parameters, comparisons, computations, etc. may be made to regulate and/or control various input and/or output parameters of regulator/charger 201.

FIG. 3 illustrates a further simplified block diagram 300 of a wireless power transfer system and an illustration of associated stability implications depicted in plot 309. With reference to block diagram 300, the wireless power transfer system can be thought of as including a source, represented by inverter 114 discussed above; a source impedance Z_source, including the respective wireless power transfer coils 112 and 122 discussed above; a load RL, represented by rectifier 124, but also reflecting regulator/charger 201, battery 202, and/or system loads 203. Stability of the wireless power transfer link can correspond to a situation where the load resistance RL is greater than the source impedance Z_source.

This may be further understood with reference to plot 309, which illustrates a series of operating curves 304–307. Each of these curves corresponds to a different input volage level (called Vboost) of the source/inverter 114. The illustrated Vboost values of 10V, 12V, 14V, and 16V are just examples, and such curves exist for any input voltage. For each/any input voltage, the curve plotted is rectifier voltage Vrect (i.e., the output voltage of rectifier 124) versus rectifier output power (Prect). As with the input voltage levels, the Vrect and Prect values given are mere examples for one potential embodiment and could take on different values depending on the particulars of a given system. Each curve will exhibit a peak 308a–308d, which corresponds to the maximum stable power level. In normal operation, it may be desirable to remain on the right-hand portion of the curve, i.e., below the peak power level, where an increase in rectifier voltage corresponds to an increase in load resistance, which allows the wireless power transfer system to remain stable. Otherwise, on the left-hand side of the curve, increases of rectifier power further lowers the load resistance, resulting in wireless power instability as described above. Thus, to ensure wireless power transfer stability, it may be desirable that the wireless power transfer system operating point always remain on the below the peak power for any inverter input voltage (Vboost) on the right-hand side of the curve.

In one aspect, the wireless power transfer system can achieve this stability as described above with reference to flowchart 201b of FIG. 2. That is, control circuitry 201a of the PRx device 220, e.g., in the regulator/charger 201, can monitor rectifier voltage (Vrect), current (Irect), and/or power (Prect) and reduce the power to keep it below a corresponding stability level 308a–308d corresponding to the operating voltage. In some applications, this control functionality could be implemented in the control and communication circuitry 116 of the PTx 110, in the control and communication circuitry 126 of the PRx 220, including combinations of the respective control circuitries. That is, circuitry in one place could communicate measured values, relevant thresholds, etc. to other devices using a communication link as described above with reference to FIG. 1, with another controller applying appropriate power limiting or reduction as appropriate to maintain stability of the system. In still other cases, the control circuitry 201a associated with regulator charger 201 could be combined with the controller and communication circuitry 126 for the wireless power receiver in an integrated controller.

In another aspect, the wireless power receiver can employ differing feedback mechanisms to further improve stability of the wireless power transfer system. To understand these different feedback mechanisms, a brief introduction into wireless power receiver load control is in order. In some wireless power transfer applications, including wireless power transfer according to standard protocols, such as the Qi wireless power transfer standards promulgated by the Wireless Power Consortium, as well as wireless power transfer according to various proprietary protocols, the wireless power receiver (PRx) may request that the wireless power transmitter (PTx) increase the level of power being transferred via the wireless link. In some cases, this can include the PRx sending a feedback packet—sometimes a controlled error packet (CEP)—via a communications link between PRx and PTx, such as the in-band communications link discussed above. This control error packet can include various data. In some embodiments, the data can include a Vrect error signal (also known as a control error signal), which corresponds to a difference between the present rectifier output voltage (Vrect) and a reference Vrect voltage that corresponds to a desired power level. The PTx can then use this error signal to either increase the wireless power transfer level if Vrect is too low as compared to the reference (meaning more power is desired) or decrease the wireless power transfer level if Vrect is too high as compared to the reference (meaning less power is desired). By periodically sending such packets, the PRx can achieve closed loop control of the level of wireless power transfer from the PTx.

In some applications, it may be desirable to use different gain values for the Vrect error signals depending on operating conditions, such as whether the Vrect error is positive (meaning that more power is desired) or negative (meaning that less power is desired). The sign of the Vrect error is merely a convention determined based on whether the Vrect value is subtracted from the reference, or vice versa. Thus, the system could function according to the same logic with a sign convention reversal to provide the operation as described below.

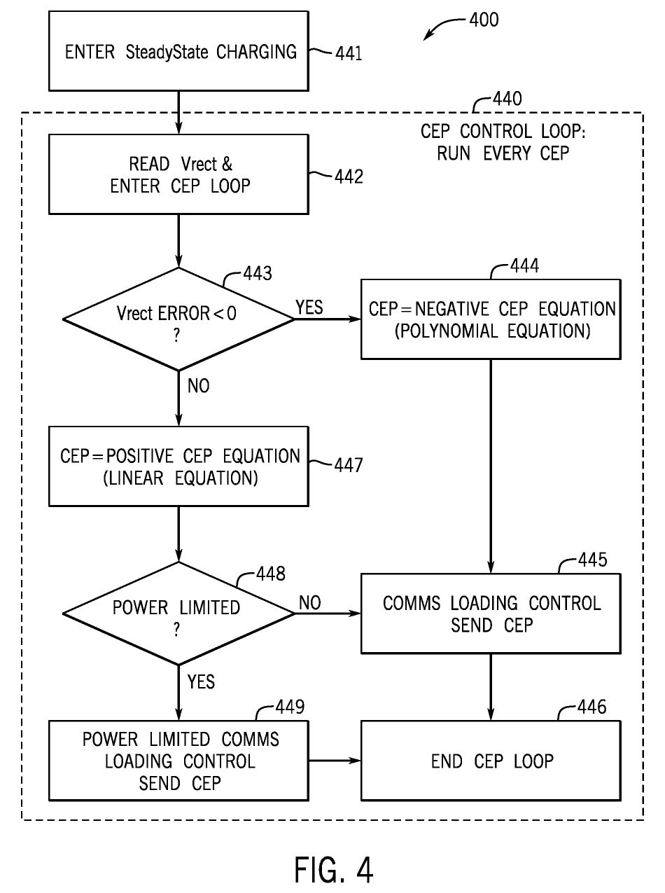

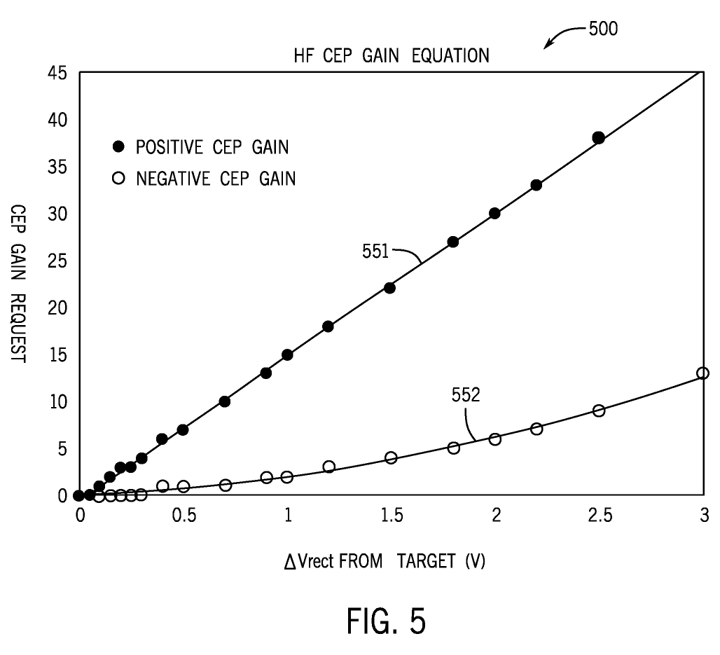

FIG. 4 illustrates a flow chart 400 of regulation and communication techniques for a wireless power transfer system. Beginning with block 441, the system can enter steady state charging after a startup process that can be defined by the standard or proprietary protocol(s) implemented by the PTx and PRx. Then, as depicted in block 442, the control circuitry associated with the PRx can read the rectifier output voltage (Vrect) and enter the CEP loop 440, which can be run for each control error packet to be sent by the PRx to the PTx. Thereafter, in block 443, the control circuitry can determine whether the Vrect error is positive or negative. If the Vrect error is positive, meaning more power is required, then, in block 447, the control circuitry can determine a CEP value based on a first equation, such as a linear equation 551 described in greater detail below with reference to FIG. 5. The effect of this linear equation can be to provide larger control error values that are proportional to the Vrect error signal, which can allow the system to more quickly reach the desired higher power level. Alternatively, if the if the Vrect error is negative, meaning less power is required, then, in block 444, the control circuitry can determine a CEP value based on a second equation, such as a quadratic (or other polynomial) equation 552 described in greater detail below with reference to FIG. 5. The effect of this higher order equation can be to provide smaller control error values that are increase monotonically with the Vrect error signal, but in a way that is not directly proportional, which can improve system stability by providing smaller step sizes when stepping down the power.

As noted above, FIG. 5 illustrates a plot 500 of respective regulation gain equations 551 and 552 for use in a wireless power transfer system. Plot 500 displays the Vrect error signal, i.e., the difference between the Vrect value and the reference or target Vrect value on the x-axis versus the CEP gain request value on the y-axis. Thus, the x-axis corresponds to the power being delivered to the loads of the PRx device by the rectifier, and the y-axis corresponds to the amount of power increase (or decrease) that is requested of the PTx by the PRx. As described above, positive CEP gain equation 551 can be used to provide a CEP signal that, for any given Vrect error produces a proportional CEP gain, which can also be larger than a corresponding CEP gain that would be produced by the negative CEP gain signal. Conversely, negative CEP gain equation 552 can be used to provide a CEP signal that, for any given Vrect error produces a non-proportional CEP gain, which can also be smaller than a corresponding CEP gain that would be produced by the positive CEP gain signal.

Both the positive and negative CEP gain functions can be defined by coefficients determined according to the particulars of a given wireless power transfer system from any combination of design, empirical testing, etc. Additionally, although the positive CEP gain equation was described as being linear, in some cases it may be desirable to use a quadratic or higher order polynomial that allows for larger increases (i.e., more than proportional increases) as the magnitude of the Vrect error increases. Likewise, although the negative CEP gain equation was described as being quadratic, higher or lower order polynomials, including linear equation could be used if desired in some cases to provide a CEP gain that increases as desired with respect to the magnitude of the Vrect error. However, for at least some applications, the linear equation producing generally larger CEP gain values for a given Vrect error and a polynomial equation producing generally smaller CEP gain values for a given Vrect error is believed to be most appropriate. As noted above, the general design considerations one would want to follow are: (1) increasing power delivery as rapidly as practical when increasing power and (2) decreasing power delivery in smaller step sizes to avoid potential stability issues when decreasing power.

Turning back to FIG. 4, and picking up at block 444, once the control circuitry determines appropriate CEP values, e.g., based on the negative Vrect error polynomial equation described above, it can transmit the CEP to the PTx (block 445). In some cases, this can include “Comms Loading Control” policy, which may include temporarily slightly reducing the power delivered from the rectifier to the system loads (and thereby reducing instantaneous power on the wireless power transfer link) to allow for more robust communication when sending the CEP to the PTx, e.g., via ASK communication, as described above. Thus, the PRx (e.g., using its control and communication circuitry) can send the CEP to the PTx during the temporary rectifier power reduction, which can be achieved, for example, by the control circuitry temporarily modifying a switching frequency, pulse width, duty cycle, etc. of the rectifier. Thereafter, the control circuitry can restore the nominal power level delivered by rectifier. The power reduction can be determined in accordance with a scale factor, such as 95%, 90%, 85%, etc. of the nominal power prior to the reduction. The scale factor to be applied can be determined based on a variety of factors, such as load magnitude, battery state of charge, etc. Once the CEP is sent and the nominal power level is restored, the CEP loop can end (block 446) to be repeated for subsequent CEPs.

Alternatively, picking up at block 447, once the control circuitry determines appropriate CEP values, e.g., based on the positive Vrect error linear equation described above, it can further determine whether the system is power limited. Determining whether the system is power limited can be done by sampling the rectifier voltage Vrect one or more times and determining whether it is within a certain range of the target rectifier voltage. If so, then the system is likely not power limited. If not, then the system may be power limited, and it may be desirable to more substantially reduce power temporarily to improve communications fidelity according to a “Power Limited “Communications Loading Control” policy. If, in block 448, the control circuitry determines that the wireless power transfer system is not power limited, the system can proceed to block 445, employing a first, lower scaling factor for the power reduction during CEP transmission as was described above. Alternatively, if the wireless power transfer system is power limited, the system can proceed to block 449, employing a second, higher (numerically lower) scaling factor to provide a larger power reduction during CEP transmission. In either case, the PTx (e.g., using its control and communication circuitry) can send the CEP to the PTx during the temporary rectifier power reduction, which can be achieved, for example, by temporarily modifying a switching frequency, pulse width, duty cycle, etc. of the rectifier. Thereafter, the control circuitry can restore the nominal power level delivered by rectifier. The power reduction in the power limited case can be determined in accordance with a second scale factor, such as 90%, 85%, 80%, 75%, 70%, 65%, etc. of the nominal power prior to the reduction. The scale factor to be applied can be determined based on a variety of factors, such as load magnitude, battery state of charge, etc. Once the CEP is sent and the nominal power level is restored, the CEP loop can end (block 446) to be repeated for subsequent CEPs.

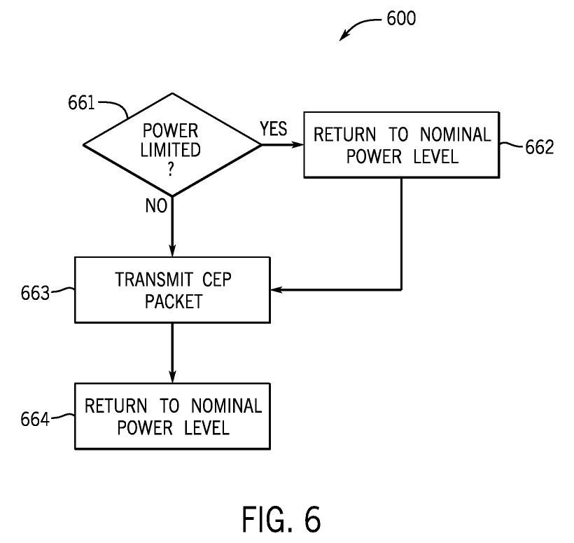

FIG. 6 illustrates a simplified flow chart 600 of a power regulation and communication technique for a wireless power transfer system relating particularly to the determination whether the system is power limited to set a power reduction for enhanced communication reliability. Beginning in block 661, the system, e.g., the control circuitry of a wireless power receiver, can determine whether the wireless power transfer system is currently power limited. If not, then, in block 663, the control circuitry can transmit a CEP packet, which can include values determined as described above with reference to FIG. 5. It should be noted that this transmission can include a slight temporary reduction in transmitter power (e.g. 5%, 10%, etc.), even though the system is not power limited. Thereafter, the control circuitry can return to the nominal power level (block 664). Otherwise, if in block 661, the wireless power receiver circuitry determines that the system is power limited, the power can be reduced by a scale factor (block 662), which can be larger than the scale factor below (e.g., a power reduction of 10%, 15%, 20%, 25%, 30%, etc.). Then, in block 663, the CEP packet can be transmitted during this larger power reduction, with the nominal power level being restored as indicated in block 664.

Described above are various features and embodiments relating to wireless power transfer techniques to prevent wireless power transfer system instabilities and provide for more robust in-band communications in wireless power transfer systems. Such arrangements may be used in a variety of applications but may be particularly advantageous when used in conjunction with electronic devices such as mobile phones, tablet computers, laptop or notebook computers, and accessories such as wireless headphones, styluses, smart watches, etc. Additionally, although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

The foregoing describes exemplary embodiments of wireless power transfer systems that are able to transmit certain information between the PTx and PRx in the system. The present disclosure contemplates this passage of information improves the devices’ ability to provide wireless power signals to each other in an efficient manner to facilitate battery charging, such as by sharing of the devices’ power handling capabilities with one another. Entities implementing the present technology should take care to ensure that, to the extent any sensitive information is used in particular implementations, that well-established privacy policies and/or privacy practices are complied with. In particular, such entities would be expected to implement and consistently apply privacy practices that are generally recognized as meeting or exceeding industry or governmental requirements for maintaining the privacy of users. Implementers should inform users where personally identifiable information is expected to be transmitted in a wireless power transfer system and allow users to “opt in” or “opt out” of participation. For instance, such information may be presented to the user when they place a device onto a power transmitter, if the power transmitter is configured to poll for sensitive information from the power receiver.

1. A wireless power receiver comprising:
a wireless power receiving coil having an AC voltage induced thereacross by a wireless power transmitting coil of a wireless power transmitter when the wireless power transmitting coil is magnetically coupled to the wireless power receiving coil;
a rectifier comprising a plurality of switching devices having an input that receives the AC voltage across the wireless power receiving coil and produces a rectifier output voltage;
wireless power receiver control circuitry that operates the switching devices of the regulator and communicates with the wireless power transmitter;
a regulator that receives the DC output voltage of the rectifier and produces a regulated output voltage provided to at least one of a battery of the wireless power receiver or one or more system loads of the wireless power receiver; and
regulator control circuitry that:
monitors at least one of the rectifier output voltage or a rectifier output current;
compares the monitored rectifier output voltage or rectifier output current a threshold; and
reduces a power level of the regulator if the monitored rectifier output voltage or rectifier output current is above a threshold, to maintain stability of a wireless power transfer link between the wireless power receiver and the wireless power transmitter.

2. The wireless power receiver of claim 1 wherein the regulator is a constant power converter.

3. The wireless power receiver of claim 2 wherein the regulator is a three-level buck converter.

4. The wireless power receiver of claim 1 wherein the threshold is selected based on an operating voltage of the wireless power transmitter.

5. The wireless power receiver of claim 4 wherein the regulator control circuitry infers the operating voltage of the wireless power transmitter from the rectifier output voltage.

6. The wireless power receiver of claim 4 wherein the regulator control circuitry receives the operating voltage of the wireless power transmitter from one of the wireless power receiver circuitry or control circuitry of the wireless power transmitter.

7. The wireless power receiver of claim 1 wherein the wireless power receiver control circuitry and regulator control circuitry are integrated into a common controller.

8. A wireless power receiver comprising:
a wireless power receiving coil having an AC voltage induced thereacross when the wireless power transmitting coil is magnetically coupled to by a wireless power transmitting coil of a wireless power transmitter;
a rectifier comprising a plurality of switching devices having an input that receives the AC voltage across the wireless power receiving coil and produces a rectifier output voltage; and
wireless power receiver control circuitry that operates the switching devices of the regulator and communicates with the wireless power transmitter, wherein the wireless power receiver control circuitry further:
monitors the rectifier output voltage and determines a rectifier voltage error by comparing the rectifier output voltage to a reference;
responsive to the rectifier voltage error indicating a need for an increased wireless power transfer level, computing a power feedback parameter based on the rectifier voltage error in accordance with a first equation;
responsive to the rectifier voltage error indicating a need for a decreased wireless power transfer level, computing the power feedback parameter based on the rectifier voltage error parameter in accordance with a second equation; and
sends a communication packet including the power feedback parameter to the wireless power transmitter.

9. The wireless power receiver of claim 8 wherein the communication packet is a control error packet, wherein the power feedback parameter is a control error packet parameter, and wherein a value of the power feedback parameter according to the first equation for a given rectifier voltage error is greater than a value of the power control parameter according to the second equation for the given rectifier voltage error.

10. The wireless power receiver of claim 9 wherein the first equation is a linear equation.

11. The wireless power receiver of claim 9 wherein the second equation is a polynomial equation.

12. The wireless power receiver of claim 9 wherein the wireless power receiver control circuitry further determines whether the wireless power transfer system is power limited; and:
responsive to the wireless power transfer system not being power limited, sends the communication packet according to a first communications loading control policy; and
responsive to the wireless power transfer system being power limited, sends the communication packet according to a second communications loading policy.

13. The wireless power receiver of claim 12 wherein the second communication loading policy provides for a temporary reduction in rectifier power during transmission of the control error packet.

14. The wireless power receiver of claim 13 wherein the temporary reduction in rectifier power corresponds to a power level selected from the group consisting of: 90%, 85%, 80%, 75%, 70%, or 65%. of rectifier power prior to the temporary reduction.

15. The wireless power receiver of claim 12 wherein the first communication loading policy provides for a first temporary reduction in rectifier power during transmission of the control error packet, and the second communication loading policy provides for a second temporary reduction in rectifier power greater than the first temporary reduction in rectifier power during transmission of the communication packet.

16. The wireless power receiver of claim 15 wherein:
the first temporary reduction in rectifier power corresponds to a power level selected from the group consisting of: 95%, 90%, or 85% of rectifier power prior to the temporary reduction; and
the second temporary reduction in rectifier power corresponds to a power level selected from the group consisting of: 90%, 85%, 80%, 75%, 70%, or 65% of rectifier power prior to the temporary reduction.

17. A wireless power receiver comprising:
a wireless power receiving coil having an AC voltage induced thereacross by a wireless power transmitting coil of a wireless power transmitter when the wireless power transmitting coil is magnetically coupled to the wireless power receiving coil;
a rectifier comprising a plurality of switching devices having an input that receives the AC voltage across the wireless power receiving coil and produces a rectifier output voltage; and
wireless power receiver control circuitry that operates the switching devices of the regulator and communicates with the wireless power transmitter, wherein the wireless power receiver control circuitry determines whether the wireless power transfer system is power limited; and:
responsive to the wireless power transfer system not being power limited, sends the control error packet according to a first communications loading control policy; and
responsive to the wireless power transfer system being power limited, sends the control error packet according to a second communications loading policy.

18. The wireless power receiver of claim 17 wherein the second communication loading policy provides for a temporary reduction in rectifier power during transmission of the control error packet.

19. The wireless power receiver of claim 18 wherein the temporary reduction in rectifier power corresponds to a power level selected from the group consisting of: 90%, 85%, 80%, 75%, 70%, or 65% of rectifier power prior to the temporary reduction.

20. The wireless power receiver of claim 17 wherein the first communication loading policy provides for a first temporary reduction in rectifier power during transmission of the control error packet, and the second communication loading policy provides for a second temporary reduction in rectifier power greater than the first temporary reduction in rectifier power during transmission of the control error packet.

21. The wireless power receiver of claim 20 wherein:
the first temporary reduction in rectifier power corresponds to a power level selected from the group consisting of: 95%, 90%, or 85% of rectifier power prior to the temporary reduction; and
the second temporary reduction in rectifier power corresponds to a power level selected from the group consisting of: 90%, 85%, 80%, 75%, 70%, or 65% of rectifier power prior to the temporary reduction.
